(19) United States
(12) Patent Application Publication
(10) Pub. No.: US 2005/0213495 A1
(43) Pub. Date: Sep. 29, 2005

(54) Image processing device

(75) Inventor: Hiroyasu Yoshikawa, Kyotanabe-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 11/079,802

(22) Filed: Mar. 14, 2005

(30) Foreign Application Priority Data
Mar. 26, 2004 (JP) 2004-091192

(51) Int. Cl. G11B 5/02; G10L 17/00; G11B 23/20

(52) U.S. Cl. 369/292; 704/246; 704/200

(57) ABSTRACT

An image processing device with a voice guidance function includes a voice guidance control key and a voice output control unit. When the voice guidance control key is operated during a voice output, the voice output control unit controls to stop the voice output. When the voice guidance control key is operated during a stop mode, the voice output control unit controls to play the stopped voice guidance.

### BACKGROUND OF THE INVENTION

1. Field of the Invention

The present invention relates to an improvement of an image processing device with a voice guidance function.

2. Description of Related Art

A recently developed image processing device such as a copying machine guides an operation method by voice to a visually-impaired person or a person unfamiliar with the operation method. Such type of device generally includes a mode switch for setting a voice output mode. Only when the voice output mode is switched on, a voice output is permitted. When the voice output mode is switched off, the voice output is prohibited.

However, in general, if a user listens to one voice guidance entirely, a long period of time is taken for the operation and the operation cannot be carried out promptly. Therefore, for many cases, when the user gets use to the operation, the user uses the image processing device with the voice output mode switched off. In an office or the like, since many users share one image processing device, the voice output mode can be switched on and off as needed. However, when the mode is switched once, an operation to restore the mode is often forgotten. As a result, in many cases, the voice is output when not needed.

In a device which is set to repeatedly output the same voice until a next operation is performed in a series of operations such as a one-touch registration operation and an error recovery operation which is carried out when an error is generated in the device, even when the operation is interrupted in the middle of the series of operations, the voice continues to be output and disturbs a person around the device. There are cases in which a voice that is hardly necessary to be heard and a voice that is necessary to be confirmed are mixed for an operation that requires such a series of operations.

In such a case, the voice output cannot be handled sufficiently just by switching the voice output mode as described above. Therefore, there is a demand for a development of a device which can easily switch validity and invalidity of the voice output as needed. A conventional facsimile machine can switch validity and invalidity of a key of an operation panel by switching on and off a key-lock switch.

### SUMMARY OF THE INVENTION

The present invention has been made in consideration of the above-described circumstances. An advantage of the present invention is to provide an image processing device which can easily switch a stop mode and a play mode of a voice guidance as needed during a guide operation.

According to an aspect of the present invention, an image processing device has a voice guidance function. The image processing device includes a voice guidance control key and a voice output control unit. In case the voice guidance control key is operated during a voice output mode, the voice output control unit controls to stop the voice output. In case the voice guidance control key is operated during a stop mode, the voice output control unit controls to play the stopped voice guidance from the beginning of the guide operation.

According to another aspect of the present invention, the image processing device further includes an operation unit which enables a prescribed registering function for the device. The voice guidance is a voice guidance output according to a registration operation of the operation unit.

According to another aspect of the present invention, the voice guidance is a voice guidance for an error recovery operation.

According to the aspect of the present invention, the image processing device includes the voice guidance control key. When the voice guidance control key is operated during the voice output mode, the voice output is stopped. When the voice guidance control key is operated during the stop mode, the stopped voice guidance is played from the beginning. Therefore, the voice guidance control key functions like an alternate key and the voice can be stopped or re-output easily as needed. Thus, even when the voice output mode is switched on, an unnecessary voice can be stopped as needed. As a result, the operation can be carried out efficiently. Even when the operation is interrupted in the middle of the operation, if the voice guidance control key is operated, the voice is not continued to be output to disturb a person around the image processing device. Even when the voice guidance is stopped once, by operating the voice guidance control key again, the stopped guidance is played. Therefore, the operation can be confirmed again by the voice.

The voice guidance control key is adopted in a device which outputs a voice guidance according to a prescribed registration operation. That is, in a series of registration operations, for an operation that does not require a voice guidance, the voice being played can be stopped and a next operation can be performed. In particular, in case many operations are required for a registration, there are cases in which a voice that is hardly necessary to be heard and a voice that is necessary to be confirmed are mixed. Since validity and invalidity of the voice output can be switched easily in such a case as needed, convenience of the image processing device is increased and an efficiency of the operation also improves.

Since validity and invalidity of the voice guidance, which is output according to the error recovery operation, can be switched, the voice can be stopped or the operation can be confirmed by the voice as needed.

### BRIEF DESCRIPTION OF THE SEVERAL VIEWS OF THE DRAWINGS

FIG. 1 is a block diagram showing an inner configuration of an image processing device according to an embodiment of the present invention.

FIG. 2 is a flowchart showing an example of an operation of a voice guidance control key according to an embodiment of the present invention.

FIG. 3 is a flowchart showing a timing of an output mode and a stop mode of a voice guidance according to an embodiment of the present invention.

FIG. 4 is a flowchart showing a basic operation of a voice output control of a device according to an embodiment of the present invention.

FIG. 5 is a time chart showing a timing of an output mode of a voice guidance according to an embodiment of the present invention.

### DETAILED DESCRIPTION OF THE INVENTION

With reference to the drawings, an embodiment of the present invention will be described. In an embodiment to be described below, a Multi Function Peripheral (MFP) is shown as an example of the image processing device. The present invention can also be applied to a facsimile machine or a copying machine.

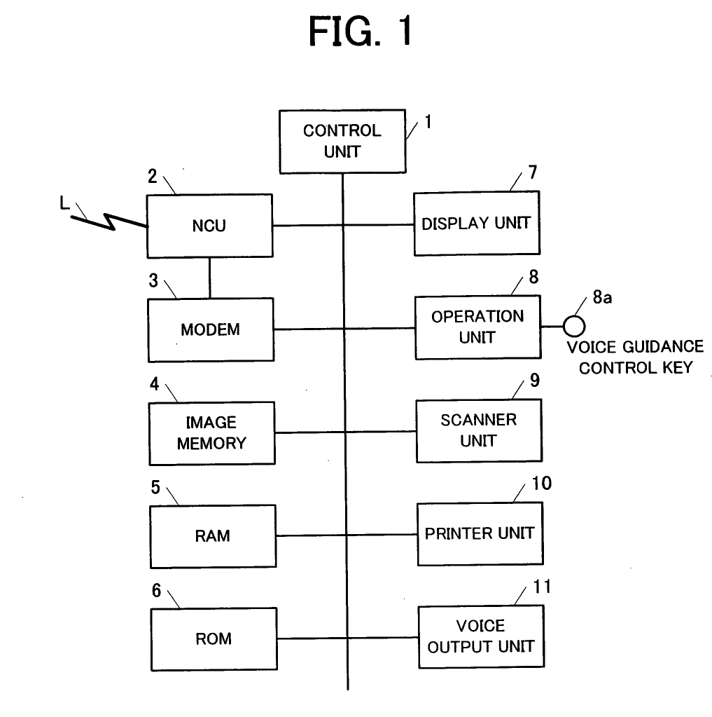

FIG. 1 is a block diagram showing an inner configuration of an image processing device F according to an embodiment of the present invention. In FIG. 1, reference numeral 1 denotes a control unit which is formed with a Central Processing Unit (CPU) or the like for controlling each of following components. The control unit 1 operates as a voice output control unit for controlling an output mode and a stop mode of a voice by an operation of a voice guidance control key 8a to be described later. Reference numeral 2 denotes a Network Control Unit (NCU) which carries out a network control of a communication line L. Reference numeral 3 denotes a modem which modulates and demodulates a signal for carrying out facsimile communication of image data. Reference numeral 4 denotes an image memory which stores image data. Reference numeral 5 denotes a Random Access Memory (RAM) which stores variable data and setting data or the like. Reference numeral 6 denotes a Read Only Memory (ROM) which stores a control program or the like. Reference numeral 7 denotes a display unit which is formed with a Liquid Crystal Display (LCD) or the like. Reference numeral 8 denotes an operation unit which is formed with a touch panel or the like. Reference numeral 9 denotes a scanner unit which scans an image of an original document. Reference numeral 10 denotes a printer unit which outputs image data of a received original document onto printing paper. Reference numeral 11 denotes a voice output unit which includes a speaker or the like for outputting a voice guidance.

The MFP F includes a facsimile transmission and reception basic function and a copying function. According to the facsimile transmission and reception basic function, the MFP F sequentially encodes image data scanned by the scanner unit 9, accumulates the image data once in the image memory 4, and transmits the image data to a destination facsimile machine (not shown) via the modem 3 and the NCU 2. Meanwhile, when the MFP F receives image data, the MFP F accumulates the received image data in the image memory 4, sequentially fetches and decodes the image data, and prints out the image data by the printer unit 10. According to the copying function, the MFP F outputs the image data scanned by the scanner unit 9 by the printer unit 10.

The MFP F includes a voice output mode switch (not shown). By operating the voice output mode switch, a voice output mode can be switched on and off. When the voice output mode is switched on, for an operation which requires a series of operations such as various registration operations and an error recovery operation, the various registration operations and the error recovery operation can be performed in accordance with a voice guidance. An example of the various registration operations is a one-touch key (telephone directory) registration. Moreover, the error recovery operation is carried out when an error generates in the MFP F.

The MFP F also includes the voice guidance control key 8a. Even when the MFP F is set under the voice output mode, the voice guidance control key 8a enables the voice guidance to be stopped at any time. When the voice guidance control key 8a is operated again during the stop mode, the stopped voice can be output again.

Next, as an example of a registration operation, a series of operations for a one-touch registration and a corresponding voice guidance will be described. (1) When a one-touch registration button is operated, a voice guidance “Please select one-touch key” is output repeatedly until a next operation is performed. (2) When a one-touch key is selected, the voice guidance “Please select one-touch key” is stopped, and a next voice guidance “Please input fax number and name” is output repeatedly until a next operation is performed. (3) When a fax number and a name are input, the voice guidance “Please input fax number and name” is stopped, and a next voice guidance “Please confirm content and operate registration fix switch” is output repeatedly until a next operation is performed. (4) When a registration fix operation is performed, the voice guidance “Please confirm content and operate registration fix switch” is stopped and a final voice guidance “One registration has been made for one-touch key XX” is output for once. In such a general voice guidance output, when the voice guidance control key 8a is operated during the output, the voice being output is stopped.

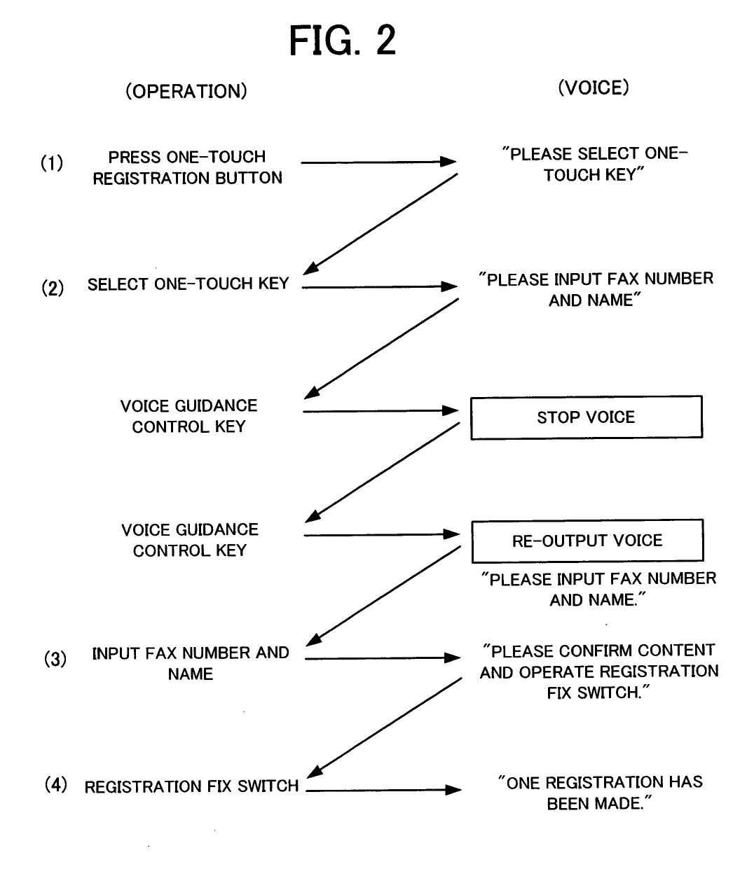

FIG. 2 shows an example of an operation of the voice guidance control key 8a in the above-described registration operation. Further, numbers (1) through (4) in FIG. 2 correspond with the above numbers. The example shown in FIG. 2 shows a case in which the voice guidance control key 8a is operated when the voice guidance of (2) is being output. When the voice guidance control key 8a is operated, the voice guidance “Please input fax number and name” being output is stopped. When the voice guidance control key 8a is operated again, the same voice guidance is output again.

That is, the voice guidance control key 8a functions as an alternate key and enables a switching operation of a stop mode and a re-output of the voice to be carried out easily as needed. Accordingly, even when the voice output mode is switched on, the voice being played can be stopped as needed. Therefore, a long voice message or a repeated voice message that is unnecessary to be heard can be stopped. As a result, the registration operation or the like can proceed efficiently and without disturbing a person around the MFP F.

Moreover, even when the voice guidance is stopped once, just by operating the voice guidance control key again, the stopped voice guidance is played again. Therefore, the operation can be confirmed again by the voice guidance. Such configuration is especially effective when the voice guidance is output repeatedly until a next operation is performed as in the present embodiment. However, even in case the voice guidance is not output repeatedly, since the voice guidance can be stopped in the midst of the message, the above-described configuration is also effective for a long message that takes a long period of time.

In the above-described embodiment, an example of the registration operation has been described. In case of an error recovery operation carried out when an error is generated in the MFP F, a stop mode and an output mode of the voice can be switched by operating the voice guidance control key 8a.

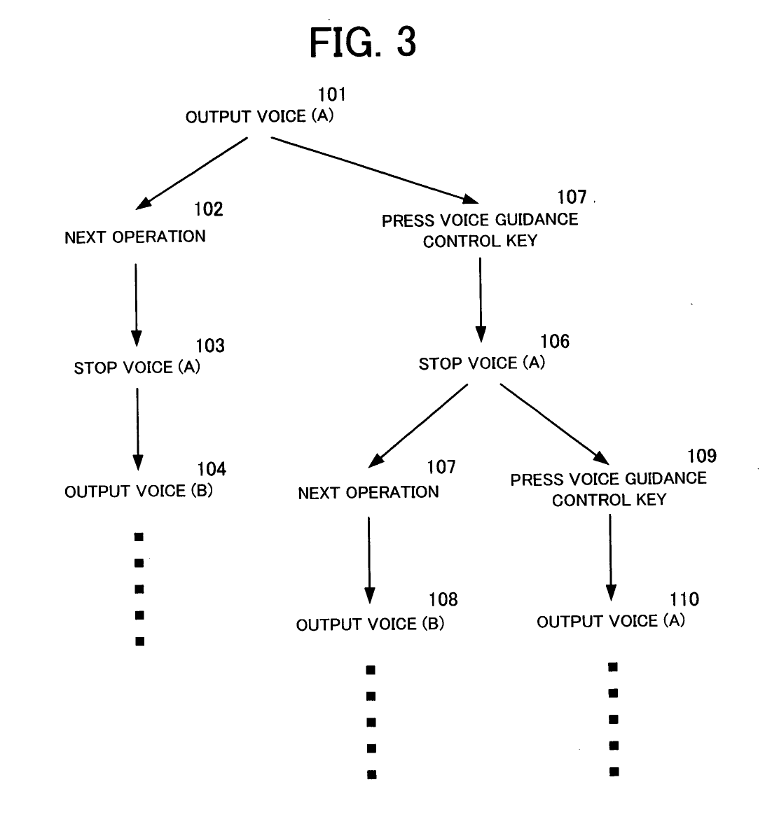

FIG. 3 is a flowchart showing a timing of an output mode and a stop mode of the voice guidance. During an output mode of a voice guidance (A), when a next operation is performed, the voice (A) is stopped and a voice (B) corresponding to a next operation is output (steps 101-104). The next operation is, for example, in the above-described one-touch registration operation, the operation (2) with respect to the operation (1), the operation (3) with respect to the operation (2) or the operation (4) with respect to the operation (3). Meanwhile, during the output of the voice guidance (A), when the voice guidance control key 8a is operated, the voice (A) is stopped and when a next operation is performed under this state, the voice (B) is output (steps 101 and 105-108). During the stopping of the voice (A), when the voice guidance control key 8a is operated, the voice (A) is output again (steps 106, 109 and 110).

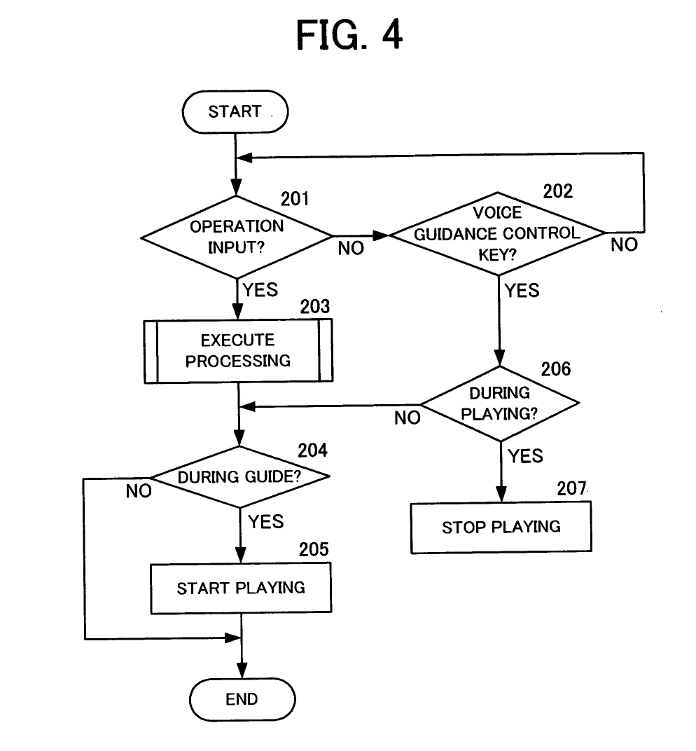

FIG. 4 is a flowchart showing a basic operation of a voice output control of a device according to an embodiment of the present invention. The flowchart shown by steps 201 through 207 shows a voice output control process carried out from when an operation of a key including the voice guidance control key 8a is accepted and until when a voice is stopped or played. In the flowchart, at step 201, an input of an operation other than the voice guidance control key 8a waits. At step 202, an input of the voice guidance control key 8a waits. At step 203, a processing at the operation of the key excluding the voice guidance control key 8a is executed. At steps 204 and 205, a search and a playing process of a corresponding voice during the guide operation are executed. Further, the voice is not played unless it is during the guide operation. At step 206, a determination is made as to whether or not the voice is being played at the input of the voice guidance control key 8a. In case the voice is being played, the playing is stopped (step 207). In case the voice is not being played, a playing process is executed (steps 204 and 205).

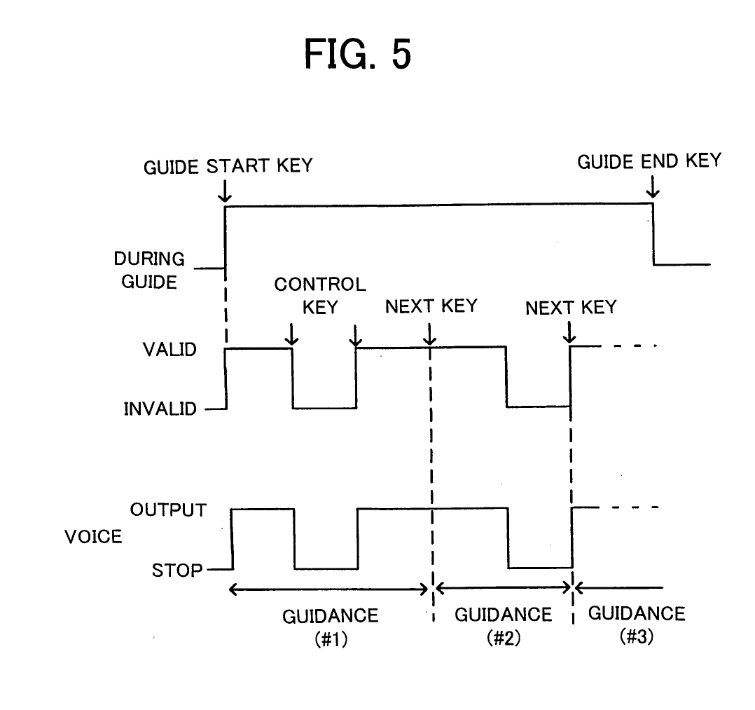

FIG. 5 is a time chart showing a timing of an output mode of the voice guidance. As shown in the time chart, a period from an operation of a guide start key until an operation of a guide end key is during the guide operation. When the voice guidance control key 8a is operated during the guide operation, an operation to switch validity and invalidity of the voice guidance is executed. The guide start key is a key for starting a voice guidance. For example, a one-touch registration button in the one-touch registration operation corresponds to the guide start key. The guide end key is a key for ending the voice guidance. For example, the registration fix switch in the one-touch registration operation corresponds to the guide end key.

1. An image processing device with a voice guidance function, comprising:
a voice guidance control key; and
means for controlling to stop a voice output during a voice guidance when the voice guidance control key is operated during the voice output and to restart the stopped voice guidance from the beginning when the voice guidance control key is operated during a stop mode.

2. The image processing device according to claim 1, further comprising means for operating which enables a prescribed registering function with respect to the image processing device, wherein the means for controlling outputs the voice guidance in accordance with a registration operation of the means for operating.

3. An image processing device with a voice guidance function, comprising:
a key for a next operation; and
means for controlling to interrupt a first voice guidance and restart a second voice guidance from the beginning when the key for the next operation is operated during an output of the first voice guidance.

4. The image processing device according to claim 1, wherein the voice guidance is a voice guidance for an error recovery operation.

5. The image processing device according to claim 2, wherein the voice guidance is a voice guidance for an error recovery operation.

6. A control method of an image processing device with a voice guidance function, comprising:
stopping a voice output during a voice guidance when a voice guidance control key is operated during the voice output; and
restarting the stopped voice guidance from the beginning when the voice guidance control key is operated during a stop mode.

7. The control method of the image processing device according to claim 6, further comprising:
accepting a prescribed registration operation for the device; and
outputting the voice guidance in accordance with the registration operation of means for operating.

8. The image processing device according to claim 1, further comprising a voice output unit.

9. The image processing device according to claim 2, further comprising a voice output unit.

10. The image processing device according to claim 3, further comprising a voice output unit.

11. The control method of the image processing device according to claim 6, further comprising outputting the voice guidance through a voice output unit.

12. The image processing device according to claim 1, further comprising a voice output mode switch that switches on and off a voice output mode.

13. The image processing device according to claim 2, further comprising a voice output mode switch that switches on and off a voice output mode.

14. The image processing device according to claim 3, further comprising a voice output mode switch that switches on and off a voice output mode.

15. The control method of the image processing device according to claim 6, further comprising switching on and off a voice output mode with a voice output mode switch.

16. The image processing device according to claim 12, wherein the voice output mode is used for a series of operations.

17. The image processing device according to claim 13, wherein the voice output mode is used for a series of operations.

18. The image processing device according to claim 14, wherein the voice output mode is used for a series of operations.

19. The control method of the image processing device according to claim 15, wherein the voice output mode is used for a series of operations.

20. The control method of the image processing device according to clam 7, further comprising accepting a one-touch registration.
